(19) United States
(12) Patent Application Publication
(10) Pub. No.: US 2011/0035263 A1
(43) Pub. Date: Feb. 10, 2011

(54) PROCESS FOR INCREASING USER-INTERACTION RATES FOR DOCUMENT ELEMENTS

(76) Inventor: Kumaresan Ramanathan, Nashua, NH (US)

Correspondence Address: Kumaresan Ramanathan, 76 Northeastern Blvd 31 A, Relona, Nashua, NH, 03062, US

(21) Appl. No.: 12/834,114

(22) Filed: Jul. 12, 2010

Related U.S. Application Data
(60) Provisional application No. 61/232,476, filed on Aug. 10, 2009.
(60) Provisional application No. 61/264,658, filed on Nov. 26, 2009.
(60) Provisional application No. 61/245,664, filed on Sep. 25, 2009.
(60) Provisional application No. 61/292,502, filed on Jan. 6, 2010.

(51) Int. Cl. G06Q 30/00; G06F 3/048

(52) U.S. Cl. 705/14.4; 715/784

(57) ABSTRACT

One embodiment of a process for improving visibility of an advertisement (110) in an interactive document (130) that is being viewed within a scrollable viewport (120). The advertisement is shown in its original location when the original location is visible within the viewport. When the viewport is scrolled, the original location of the advertisement moves out of the viewport and is no longer visible. When this happens, the advertisement is shifted to a new location. The advertisement in its second location becomes visible within the viewport for a second time as the user continues to scroll through the document. Since the advertisement is viewed more than once, it gets noticed more by users. The locations of the advertisement can be separated by content or other advertisements. Other embodiments are described and shown.

### CROSS-REFERENCE TO RELATED APPLICATIONS

This application claims the benefit of provisional patent application Ser. No. 61232476 filed Aug. 10, 2009 by the present inventor, provisional patent application Ser. No. 61264658 filed Nov. 26, 2009 by the present inventor, provisional patent application Ser. No. 61245664 filed Sep. 25, 2009 by the present inventor, and provisional patent application Ser. No. 61292502 filed Jan. 6, 2010 by the present inventor.

### COPYRIGHT

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

### BACKGROUND

The following is a list of some patent application references that presently appears relevant:
1. United States Patent Application 20040267806

Kind Code A1

Lester, Chad Dec. 30, 2004
2. United States Patent Application 20070192794

Kind Code A1

Curtis; Christian M.; et al. Aug. 16, 2007

Many websites generate revenue from advertisements. The revenue generated from advertisements often depends on the extent to which users engage with advertisements on the site. One way to measure user engagement is through the click-through-rate. The click-through-rate is the number of clicks an advertisement receives for a specific number of times that the advertisement is viewed. Usually the click-through-rate is expressed as a percentage.

When the click-through-rate on a site is high, advertisers are usually willing to pay higher rates to run their advertisements on that site. Conversely, a site with low click-through-rates usually earns less from advertisements.

Website owners (i.e. publishers) have tried many techniques for increasing user-engagement for their advertisements.

One technique to make advertisements more visible and increase user-engagement is to slide an advertisement so that it remains within the user's browser window. An advertisement that always remains within the user's browser is likely to be noticed more and get more clicks. However, users generally dislike the jerky movement that occurs when advertisements slide. In addition, sliding advertisements need contiguous empty areas on the web-page where the advertisement can slide. Having such large empty areas can be difficult in sites where both content and advertisements are competing for valuable real estate on the page. Sliding advertisements suffer from an additional problem—users often resent the sliding advertisement as an attempt to increase clicks. This can drive away users and reduce a site's traffic. Lower traffic can lead to lower revenues.

### SUMMARY

In accordance with one embodiment, a process for improving visibility of an advertisement in an interactive document displayed within a scrollable viewport comprises choosing two or more locations within the document so that these locations are separated by other items, displaying the advertisement in the first location when the first location is visible within the viewport, scrolling the viewport, and shifting the advertisement to the second location when the second location becomes visible within the viewport.

In accordance with another embodiment, a process for improving click-through-rates of a web-page advertisement comprises choosing two or more locations within the web-page so that the locations are separated by other items (such as content or other advertisements), displaying the advertisement in the first location, scrolling the web-page, and shifting the advertisement to the second location when the second location becomes visible within the web-browser.

In accordance with another embodiment, a process for improving click-through-rates of a web-page advertisement comprises the following:
The advertisement is shown at the top of the web-page when the page first loads in a user's web-browser. At this point, the web-browser is also scrolled to the top of the page, so the advertisement is visible within the browser window.
As the user scrolls down to read the rest of the page, the advertisement moves up and disappears off the top of the browser.
The advertisement is then shifted to a second location further down on the page. The second location is chosen so that it is below the area visible within the web-browser window. When the shift happens, both the first and second locations of the advertisement are outside the area displayed within the web-browser, so the user will not notice this shift happening.
As the user continues to scroll down further, the second location comes into view in the web-browser and the user views the advertisement for a second time.
   To the user it appears as though there are two instances of the advertisement on the page. But in reality there is only one instance of the advertisement. The single advertisement instance changes its location as the user scrolls so that it is viewed by the user more than once. This process works even when the two locations of the advertisement are separated by other page elements.

Accordingly several advantages of one or more aspects are as follows: to increase user-engagement with advertisements on a web-page for pages that don't have enough areas of contiguous empty space for advertisements to slide, to increase click-through-rate of advertisements, to increase visibility of advertisements on a web-page while keeping the total number of impressions the same, to increase clicks on an advertisement without users being aware that the advertisement is being shifted from location to location, to increase clicks without annoying users, to show advertisements with multiple messages where each location displays a different message and thereby avoid user fatigue, and to show an advertisement in multiple locations without increasing page size (in terms of bytes to be loaded). Other advantages of one or more aspects will be apparent from a consideration of the drawings and ensuing description.

### DRAWINGS—FIGURES

FIG. 1 shows a web-page with a browser window on top of the page and an advertisement displayed at a location on the page such that the advertisement is visible within the browser.

FIG. 2 shows the web-page with the browser scrolled partially down. The advertisement continues to be displayed in its original location near the top of the page.

FIG. 3 shows the web-page with the browser scrolled partially down. The advertisement has been shifted to its second location towards the end of the page.

FIG. 4 shows the web-page with the browser scrolled down further. The advertisement in its second location is visible within the browser.

FIG. 5 shows how the space occupied by the advertisement in the first location can be reclaimed once the advertisement shifts to its second location. The browser is partly scrolled down and the space occupied by the first location has been reclaimed.

FIG. 6 shows the browser scrolled down until the second location of the advertisement is visible within the browser. The advertisement is in the second location and the space occupied by the first location has been reclaimed.

FIG. 7 shows a composite advertisement in two halves. The upper half has one message (marked with a U). The lower half has another message (marked with L).

FIG. 8 shows a web-page that displays the upper half of the composite advertisement at the top of the page. The browser is also at the top of the page and the upper-half of the advertisement is visible within the browser.

FIG. 9 shows the web-page with the lower half of the composite advertisement at the second location. The browser has scrolled down and the second location is visible within the browser.

FIG. 10 shows a web-page with the browser scrolled down. The advertisement is at the second location and it has been resized.

FIG. 11 is a flowchart for how an advertisement can be displayed in two locations as the browser scrolls.

FIG. 12 is a flowchart for how space can be reclaimed when an advertisement shifts its location.

FIG. 13 is a flowchart for showing different messages at different location using a composite advertisement.

FIG. 14 is a flowchart for tracking clicks on an advertisement

FIG. 15 shows a web-page with a web-browser scrolled partly down, the space used by the first location has been reclaimed, and advertisement-B is displayed in the second location.

FIG. 16 shows a web-page with a web-browser scrolled down, the space used by the first location has been reclaimed, and advertisement B is in the second location.

FIG. 17 is a flowchart for displaying advertisement A and B in different locations with space being reclaimed when advertisement A is not visible within the web-browser window.

FIG. 18 is a schematic of a data processing system that shows advertisements in different locations according to the scroll-location of the web-browser.

FIG. 19 is a flowchart for using heuristics to optimize the visibility of advertisements within the web-browser window.

FIG. 20 is a flowchart for recording scrolling behavior

FIG. 21 is a flowchart for restarting the animation in the advertisement

FIG. 22 shows a web-page with a browser window on top of the page and an advertisement A displayed at a location on the page such that the advertisement is visible within the browser.

### DRAWINGS—REFERENCE NUMERALS

110 Advertisement

120 Web Browser window

130 Web-Page with 2 column layout

140 Document items (i.e. content or other advertisements) in right-column of web-page that are in between the first location and the second location

150 Content in left column of web-page

710 Upper half of composite advertisement

720 Lower half of composite advertisement

810 Composite advertisement clipped so that upper-half alone is visible

910 Composite advertisement clipped so that lower-half alone is visible

1010 Resized advertisement

1110 Step of choosing first location for advertisement in the web-page layout.

1120 Step of choosing second location for advertisement in the web-page layout.

1130 Step of displaying advertisement at the first location

1140 Step of shifting advertisement to the second location when the web-browser window scrolls down the page.

1150 Step of displaying advertisement in the second location within the web-browser window

1210 Step of reclaiming space used by the first location. Content in the rest of the page is moved so that the space originally occupied by the first location is reclaimed.

1310 Step of clipping composite advertisement so that upper half alone is visible

1320 Step of clipping composite advertisement so that lower half alone is visible

1410 Step of waiting for user to interact with advertisement

1420 Step of recording details of user's interaction with advertisement to a server

1510 Advertisement B in second location

1710 Step of choosing first location for advertisement A inside page layout

1720 Step of choosing second location for advertisement B

1730 Step of displaying advertisement A at first location

1740 Step of reclaiming space used by advertisement A at first location

1750 Step of displaying advertisement B at second location

1760 Step of viewing advertisement B at second location within browser window

1810 Display manager. Includes means for determining which part of interactive document is visible within viewport.

1820 Layout manager: Includes means for choosing first location, means for choosing alternative location, and means for shifting location of advertisement.

1830 Viewport: Displays a portion of interactive document. This is may be implemented as a web-browser.

1840 Interactive document such as a web-page

1850 Scrolling means

1860 Advertisement

1910 Step of using heuristics to determine when to shift advertisement to second location so that visibility of advertisement is increased

2010 Step of recording scrolling behavior and scrolling history

2110 Step of replaying animation in advertisement

2210 Advertisement A in first location

### DETAILED DESCRIPTION

### First Embodiment

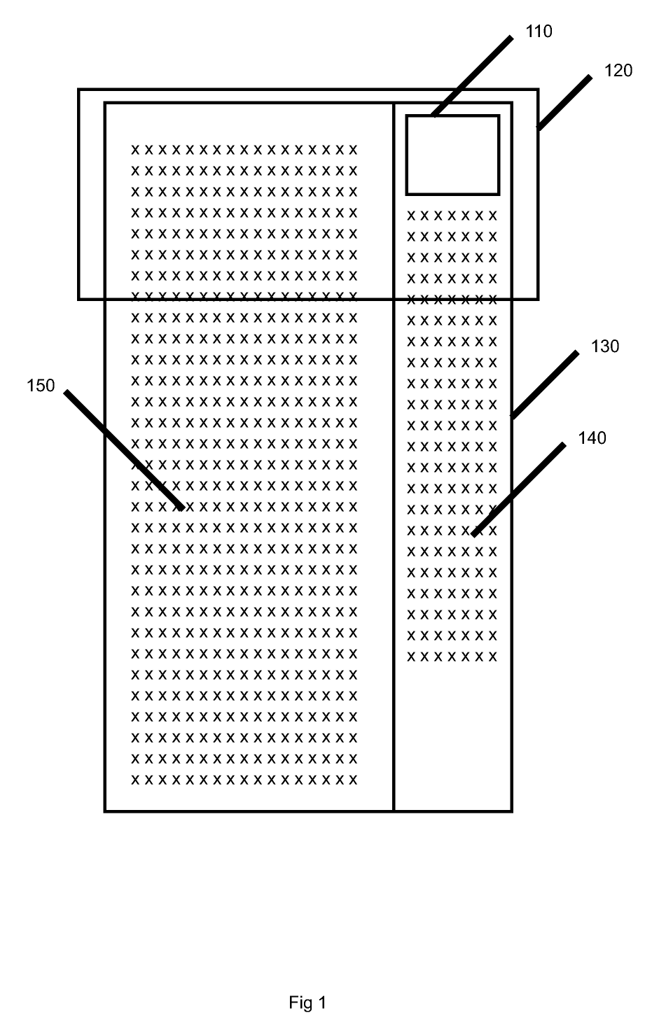

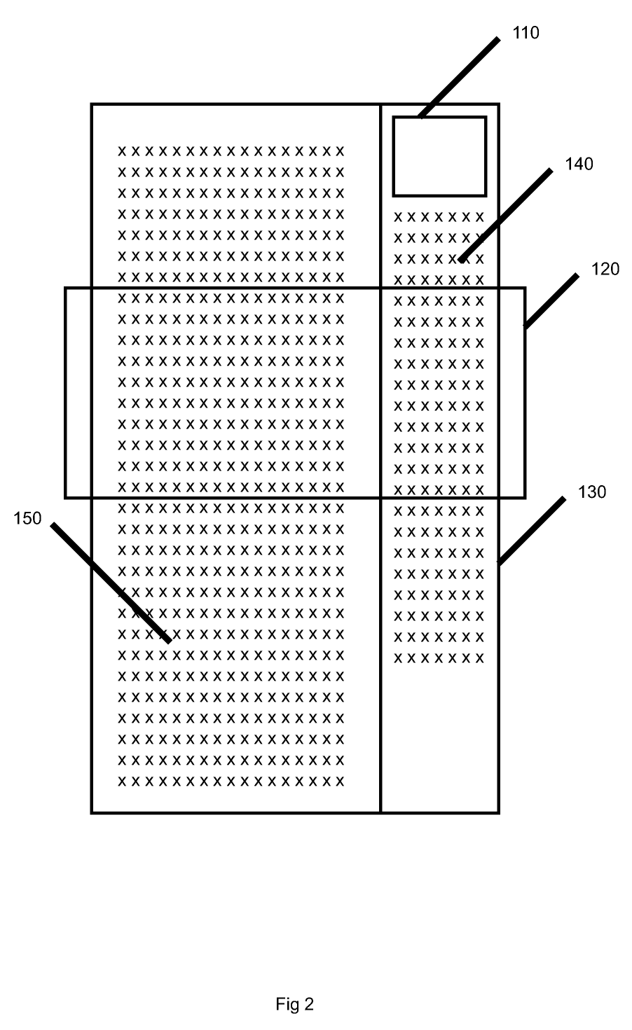

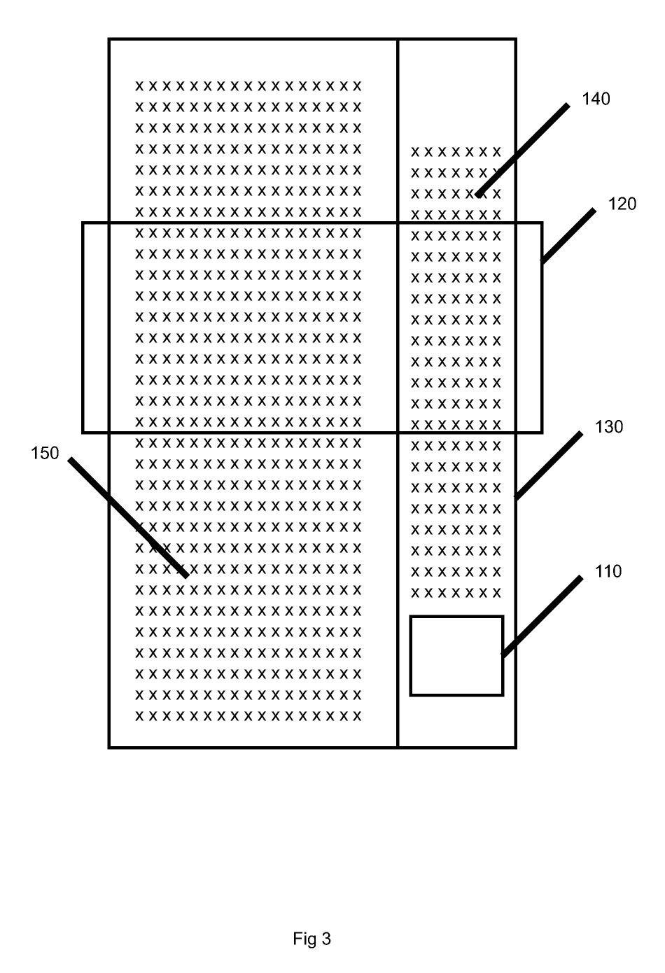

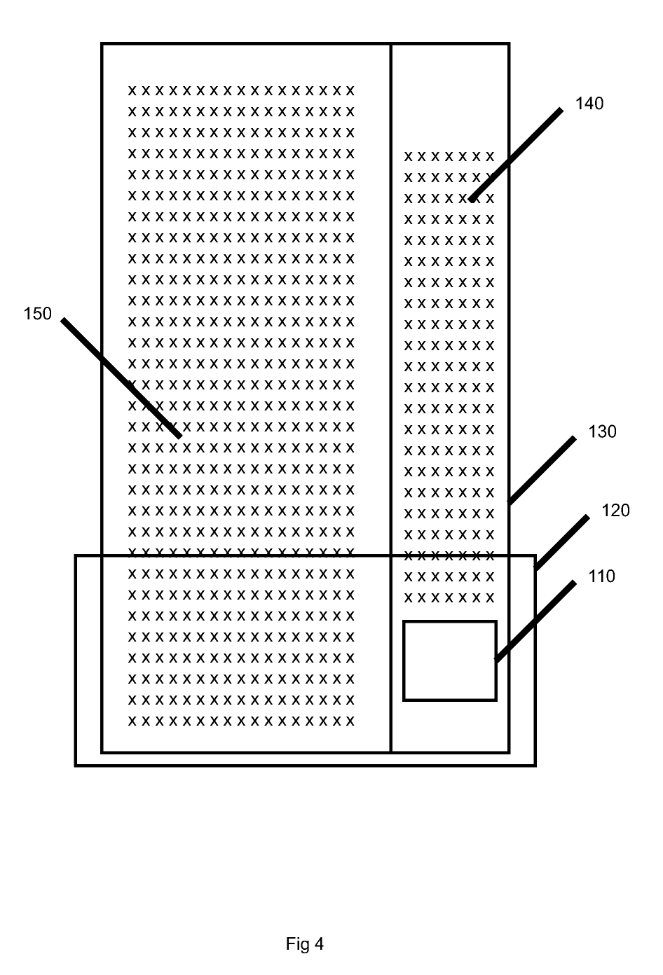

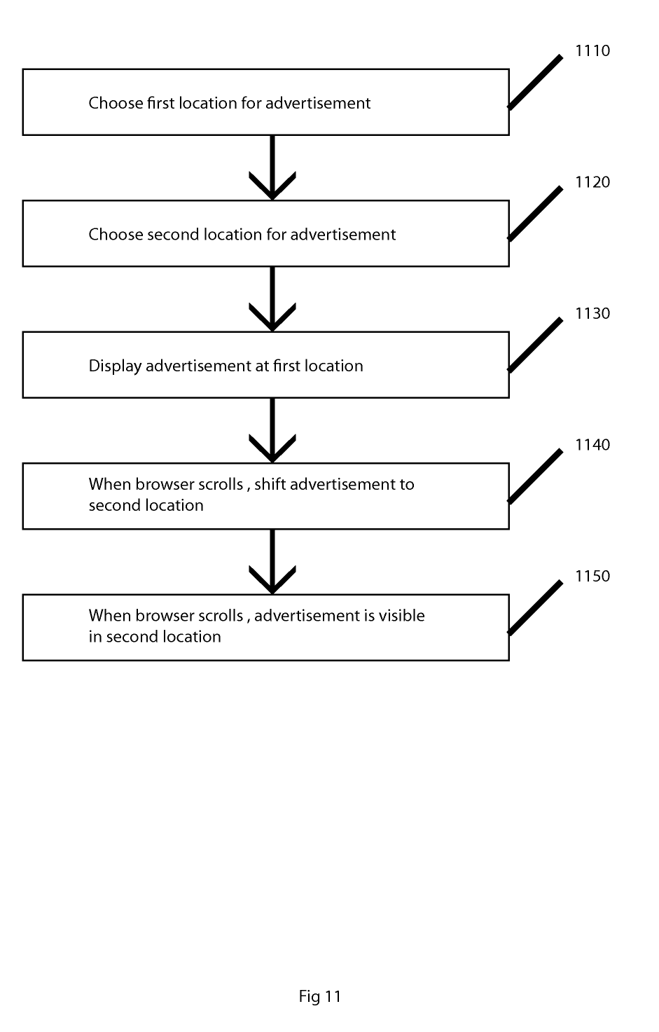

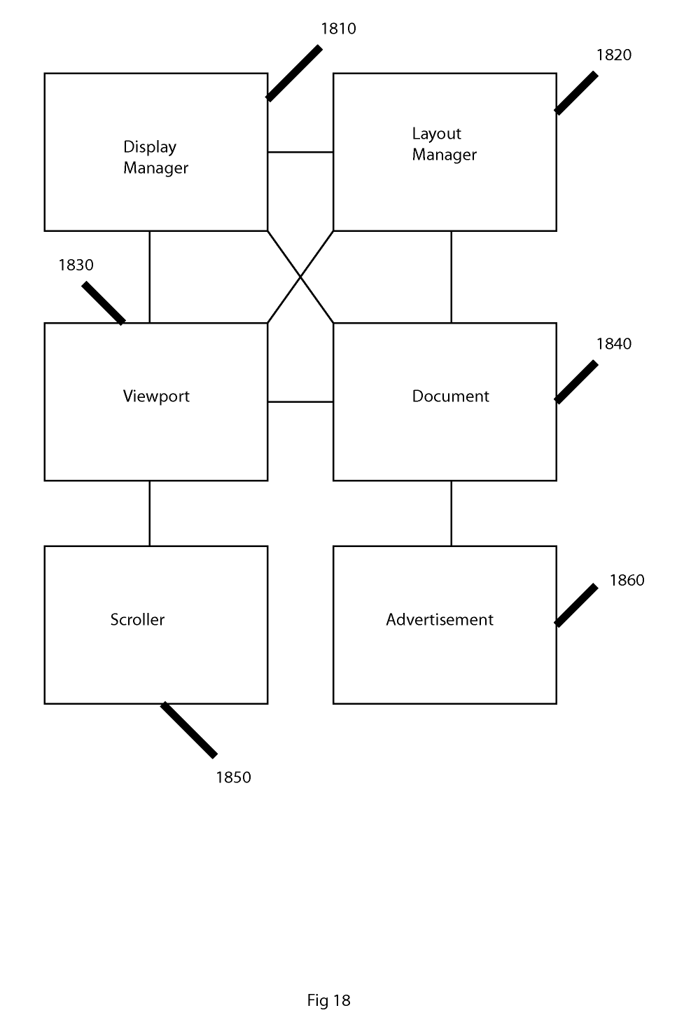

One embodiment is illustrated in FIG. 1, FIG. 2, FIG. 3, FIG. 4, FIG. 11, and FIG. 18. When an interactive document such as a web-page loads in a viewport such as a web-browser window, the situation is illustrated in FIG. 1. The web-page 130 is taller than the web-browser window 120. The web-page layout has two columns. The left-column contains non-commercial content 150. The right column contains both commercial as well as non-commercial content. Commercial content is generally referred to as an advertisement. For the purpose of this discussion, an advertisement is any element of an interactive document that can produce commercial benefit when users interact with the element. In FIG. 1, an advertisement instance 110 is located at the top of the right-column. Below the advertisement is content 140 that extends part-way down the right-column. Since the web-page 130 is taller than the web-browser 120, only a portion of the web-page is visible within the web-browser. As the user scrolls down to read the rest of the page, the portion of the page that was originally visible within the window moves up and out of the window. The situation after scrolling down part-way is illustrated in FIG. 2. The advertisement instance 110 is no longer visible within the web-browser 120. A user is likely to scroll all the way down the web-page while reading the main content. Since the user has scrolled past the advertisement instance, leaving the advertisement instance in its original location will mean that it will continue to be ignored by the user. So the advertisement instance is now shifted to a new location where the user is likely to see it again. FIG. 3 illustrates how the advertisement instance 110 is shifted to a new location after the right-column content 140. As the user continues to scroll down the page while reading the main content, the user will see the advertisement instance again. FIG. 4 illustrates how the advertisement instance 110 in its new location appears for a second time within the browser window 120 when the user scrolls down to the end of the page.

If the user were to scroll back up, the advertisement instance would also shift back to the top of the page.

FIG. 11 is a flowchart of this embodiment. The first location of an advertisement instance is chosen 1110 by the person who creates the layout of the web-page. Similarly a second location is chosen 1120. The advertisement is displayed at the first location 1130. When the browser scrolls down, the advertisement instance moves up and out of the browser window. After the advertisement instance moves off the top of the browser window, the advertisement instance is shifted to the second location 1140. The advertisement instance scrolls into view in the browser 1150.

FIG. 18 is a schematic of this embodiment. A data processing system comprises an interactive document 1840 that contains an advertisement instance 1860, a viewport 1830 that has a means to scroll 1850, a layout manager 1820 that determines the locations of the contents of the document, and a display manager 1810 that displays a portion of the document inside the viewport. The interactive document may be a web-page. The viewport is typically a web-browser window. The layout manager is typically a HTML and CSS rendering engine. The display manager is typically a web-browser engine together with its UI controls for scrolling and browsing documents. The logic for shifting the location of the advertisement instance when the document is scrolled is executed within the layout manager.

The location of the advertisement instance is shifted using CSS (cascading style sheets) positioning attributes. CSS positioning allows an element to be accurately placed anywhere on the page. Use of CSS positioning is advantageous because if the advertisement were created using a javascript call that places the advertisement media on the page, then using CSS positioning will not invoke the javascript functions again. Invoking the javascript more than once, or using DOM insertion and deletion to move the advertisement might interfere with the advertisement's behavior. To use CSS positioning, a CSS style of “position:absolute” is given to the element (in this case the advertisement) that is to be positioned. Next the element is also given CSS styles for “left” and “top”. The “left” attribute gets the coordinate of the x-axis. The “top” attribute gets the y-coordinate. By changing the values of the CSS “left” and “top” attributes using Javascript, the position of the element may be shifted.

Standard javascript functions, javascript events, and the DOM (document object model) can be used to find out how the page has been scrolled within the browser. In particular, javascript can be used to determine when the browser-window has scrolled completely past the first location and the advertisement instance is no longer visible within the browser window. At this point, the advertisement instance is shifted to the second location using CSS positioning.

Conversely, if the user scrolls back up, then the second location will move down and out of the browser window. After the second location disappears off the bottom of the browser-window, the advertisement instance is shifted back to the first location.

The software listing in the file multilocation.html illustrates one way to implement the above embodiment. Instructions on how to run the software files are provided elsewhere in this specification. Open the multilocation.html file in a browser according to the instructions. An advertisement is shown as a yellow rectangle at the top of the right-column. In the code, the advertisement is the DIV with an ID of “advertisement”. Upon scrolling down, the location of this advertisement instance is shifted to the end of the right-column. The advertisement instance appears within the browser window for a second time when the browser is scrolled all the way down.

### Additional Embodiment

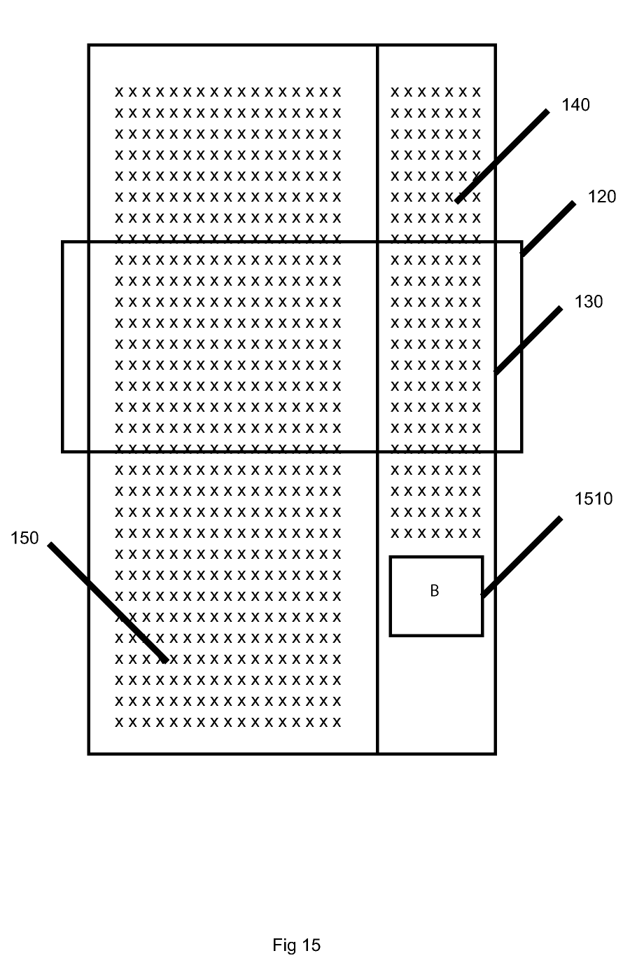

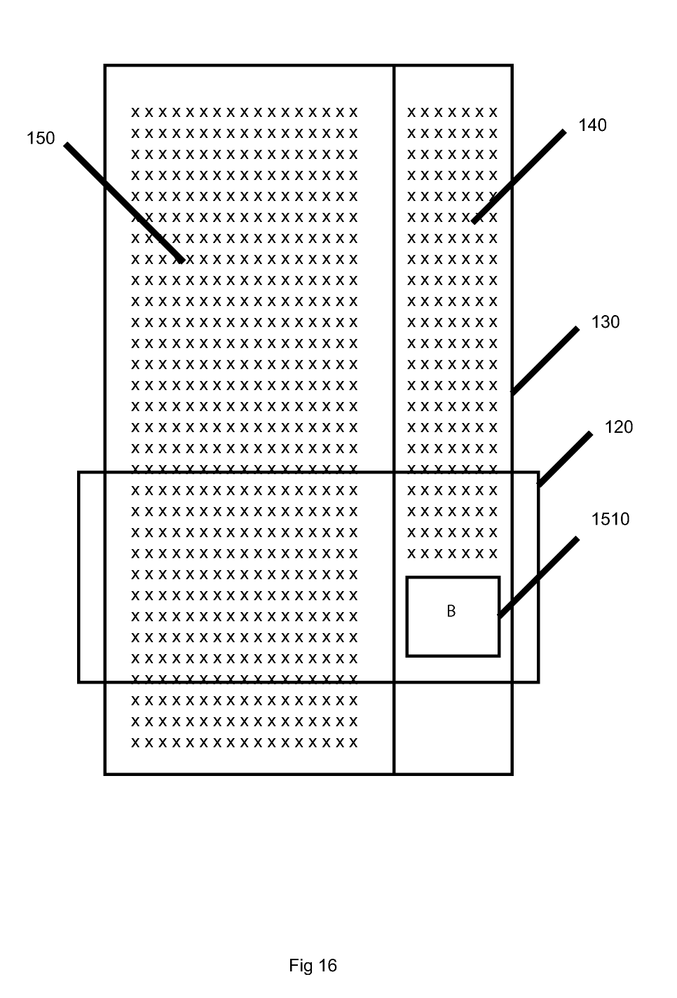

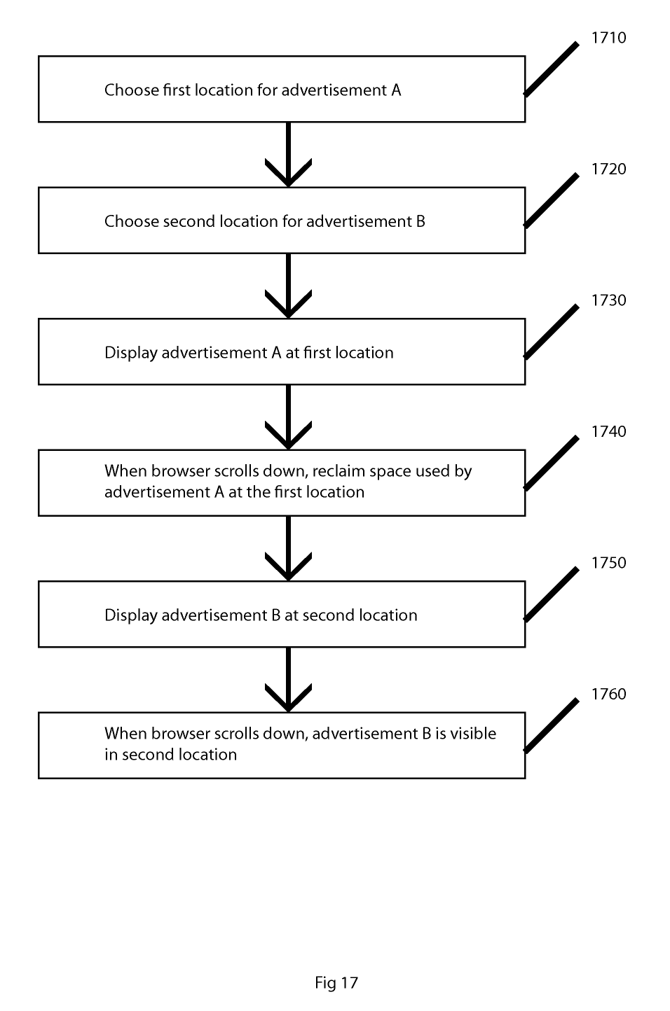

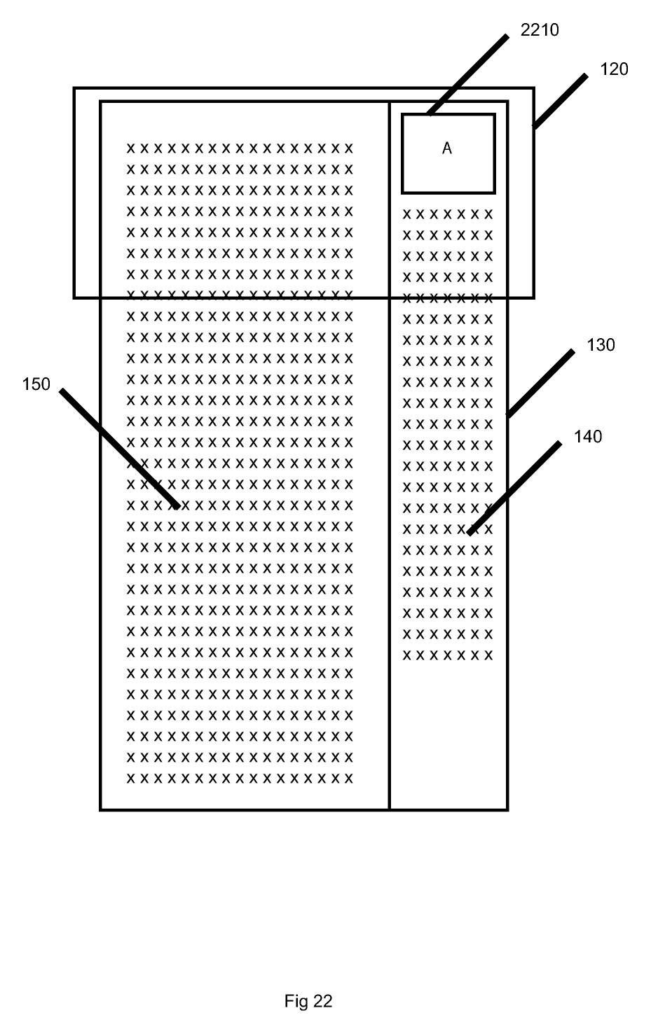

An embodiment is illustrated in FIG. 15, FIG. 16, FIG. 17, and FIG. 22. FIG. 22 illustrates an advertisement-A 2210 that appears at the top of web-page 130. Advertisement-A is visible within web-browser window 120. As a user scrolls down the web-page, the advertisement-A 2210 moves up and out of the web-browser window 120. Since advertisement-A is no longer visible within the browser, it is now hidden (or deleted). Next, the space that was originally occupied by advertisement-A is reclaimed by shifting the right-column contents 140 up to the top of the web-page. Shifting the right-column contents 140 up opens up additional space at the end of the right-column. An advertisement-B is displayed in the newly opened up space at the end of the right-column. FIG. 15 illustrates how advertisement-B 1510 is displayed at the end of the right-column in the newly opened up space. As the user scrolls down, FIG. 16 illustrates how the advertisement-B 1510 becomes visible within the browser 120.

FIG. 17 is a flowchart of this embodiment. A first location for an advertisement-A is chosen 1710. A second location for an advertisement-B is chosen 1720. Advertisement-A is displayed at first location 1730. When user scrolls down, advertisement-A moves up and out of the browser-window. At this point, hide (or delete or remove) advertisement-A and reclaim the space used 1740. Reclaiming space at the first location opens up space at the second location. Advertisement-B is displayed in the newly opened up space at the second location 1750. When the user scrolls down further, advertisement-B in the second location is visible within the browser window 1760.

The process of reclaiming space involves rearranging elements on the web-page. Elements may be rearranged either through CSS positioning, and/or by changing the dimensions of elements through CSS.

### Additional Embodiment

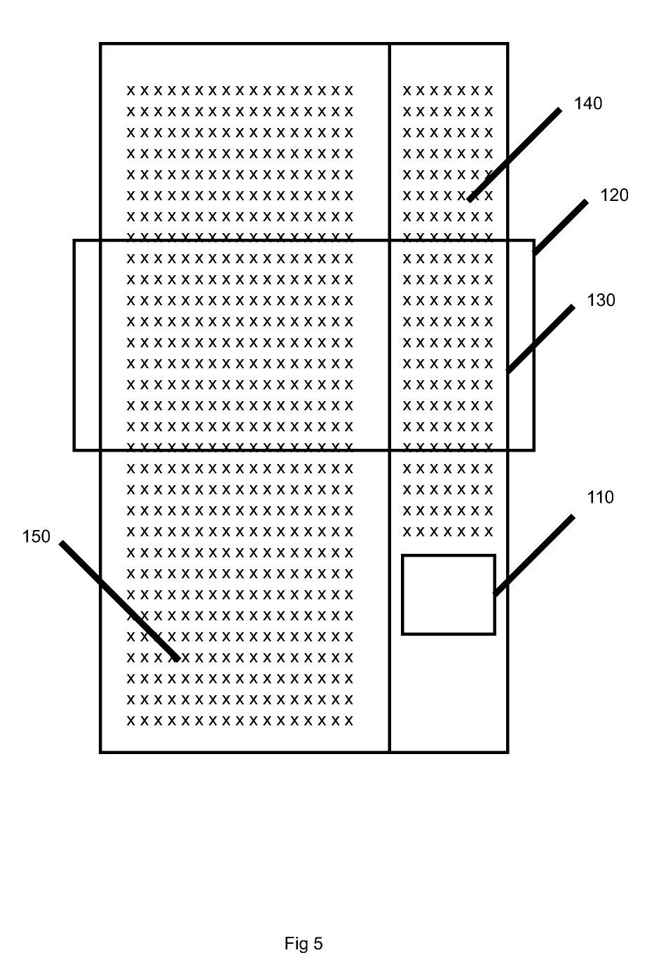

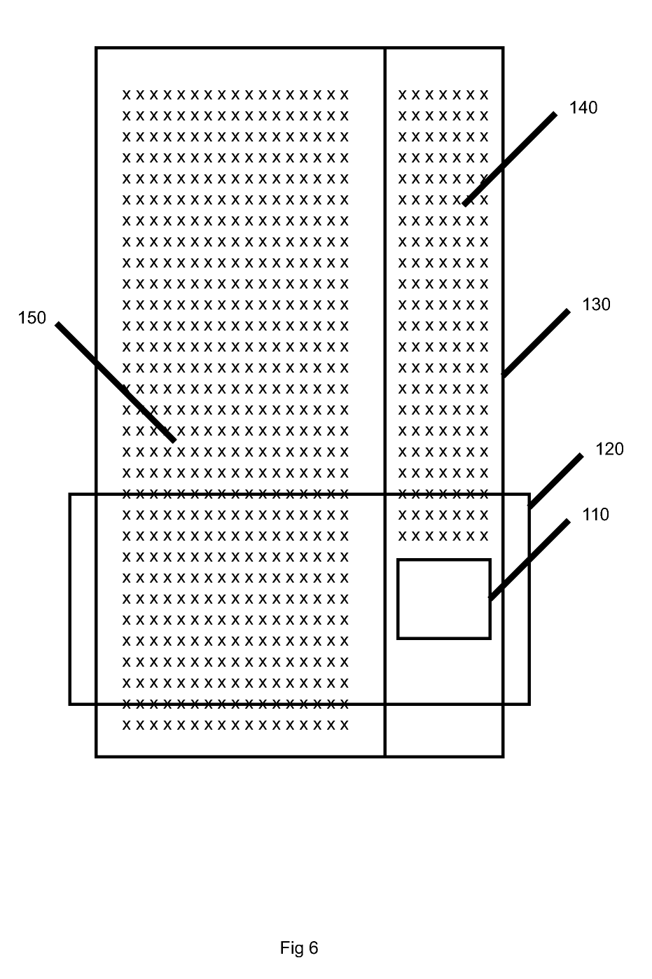

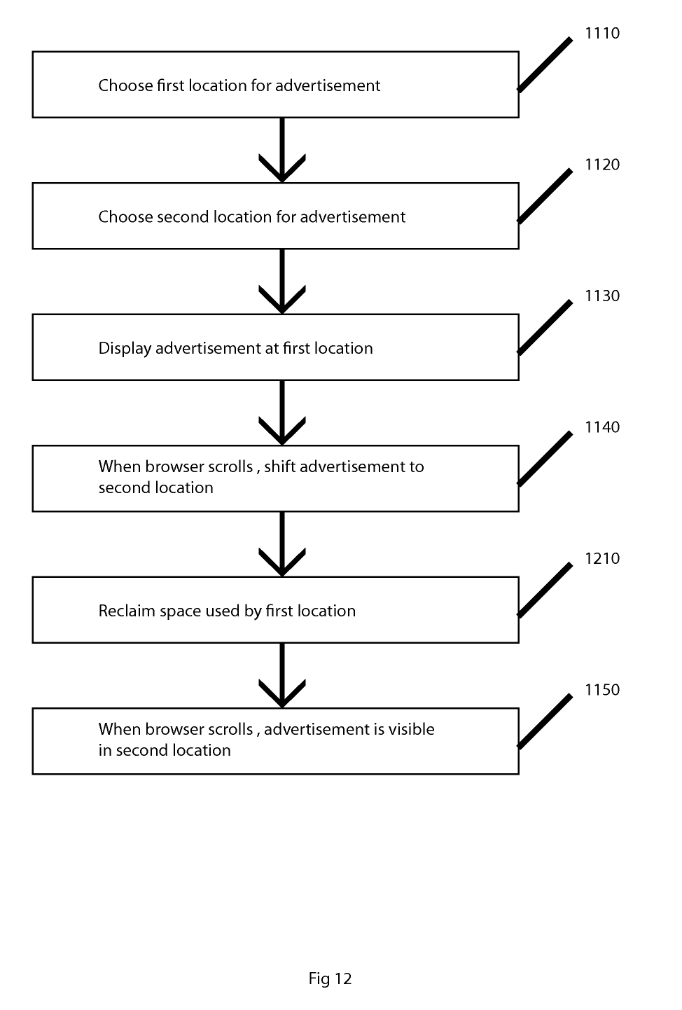

An embodiment is illustrated in FIG. 1, FIG. 5, FIG. 6, and FIG. 12. Consider FIG. 1. When a web-page 130 first loads in a browser 120, an advertisement instance 110 in the page is located at the top and is visible within the web-browser. When a user scrolls down to read the rest of the page, the advertisement instance moves up and out of the browser window. At this point, the advertisement instance is shifted out of that location and the space originally occupied by the advertisement is reclaimed by moving other contents of the right-column upward as illustrated in FIG. 5. The advertisement is displayed in the second location (at the end of the right-column) after it is shifted out of the first location. When the user continues to scroll down, the advertisement instance becomes visible again within the browser as illustrated in FIG. 6.

Reclaiming the space originally occupied can be done in steps. That is, as the user scrolls down, more and more of the space can be reclaimed until all of it has been fully reclaimed. This can produces a more pleasing effect for the user who is reading the page.

FIG. 12 is a flowchart of this embodiment. Steps 1110, 1120, 1130, 1140, and 1150 have already been discussed. Step 1210 is to reclaim the space originally used by the advertisement by shifting other content into that original space. This opens up new space in another location of the web-page.

The functionality to reclaim space would typically be a part of a layout manager such as 1820.

Software listings in the files shufflejump.html, shufflesmooth.html, and shufflestep.html illustrate how to implement this embodiment. Open shufflejump.html in a browser (as described in instructions elsewhere in this specification). Observe the right-column carefully to see how content moves when space occupied by the original location of the advertisement is reclaimed. Open shufflesmooth.html in a browser. Contents in the right-column move up smoothly to reclaim space. Open shufflestep.html in a web-browser. Contents in the right-column move in smaller increments to reclaim the space originally occupied by the advertisement.

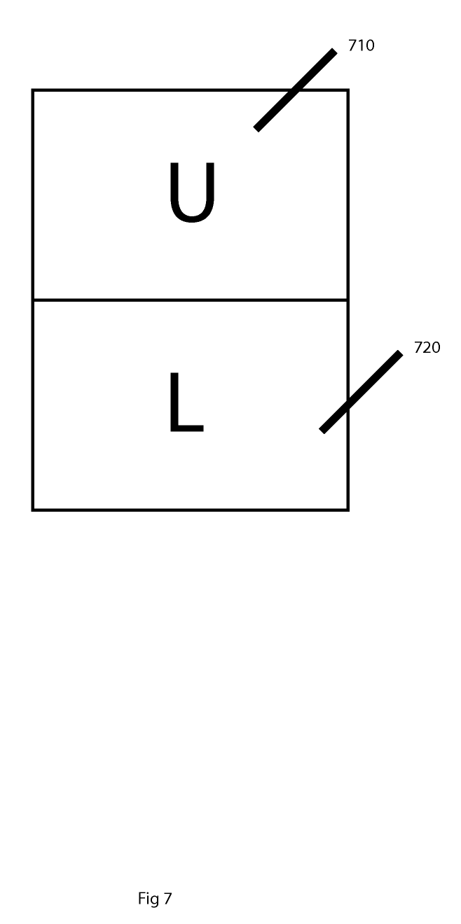

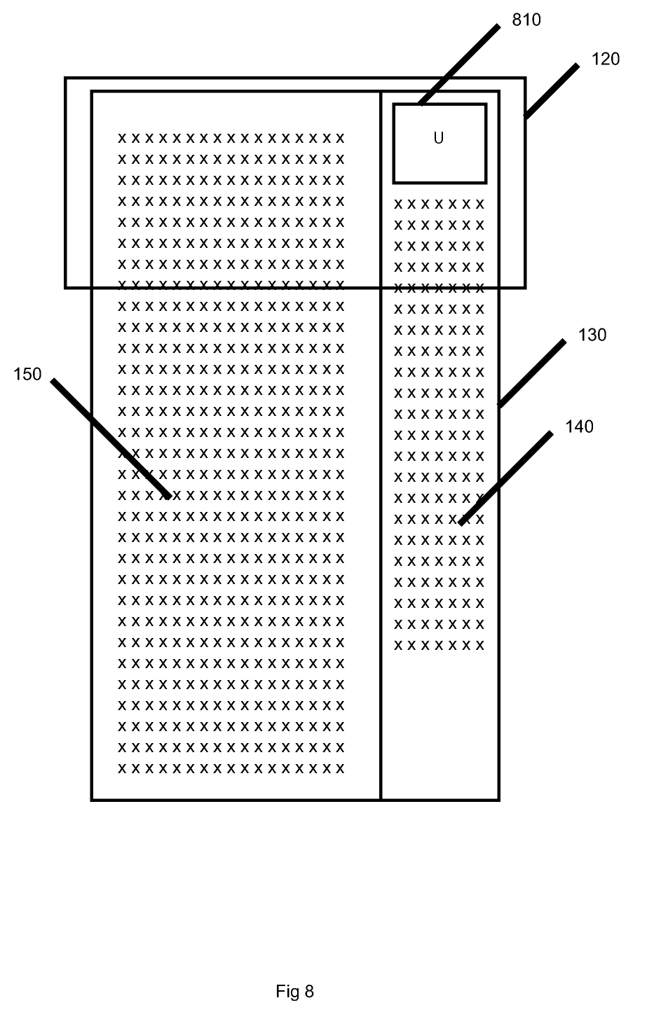

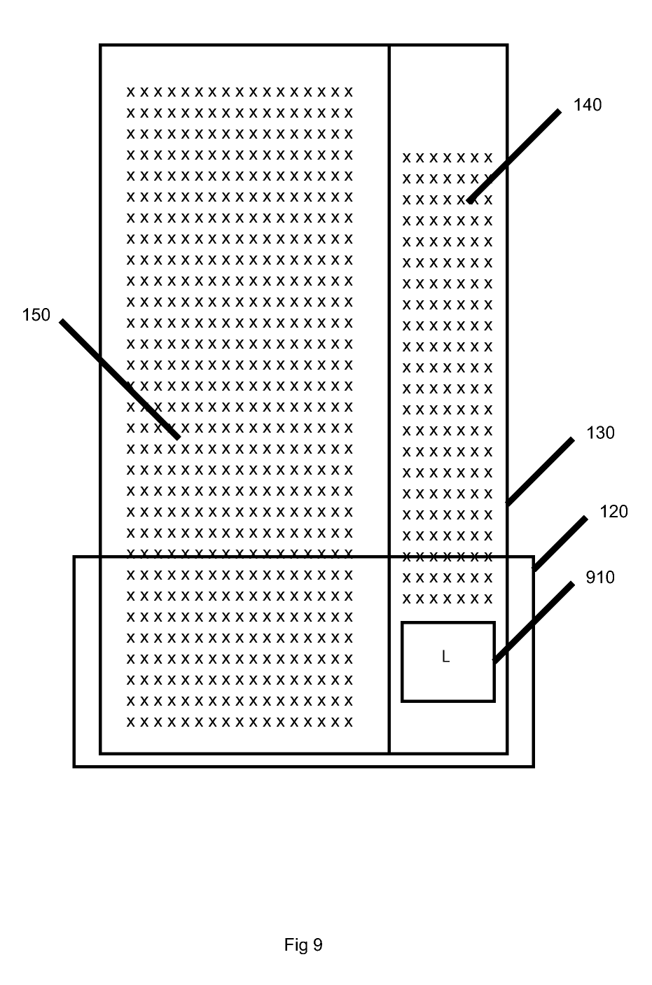

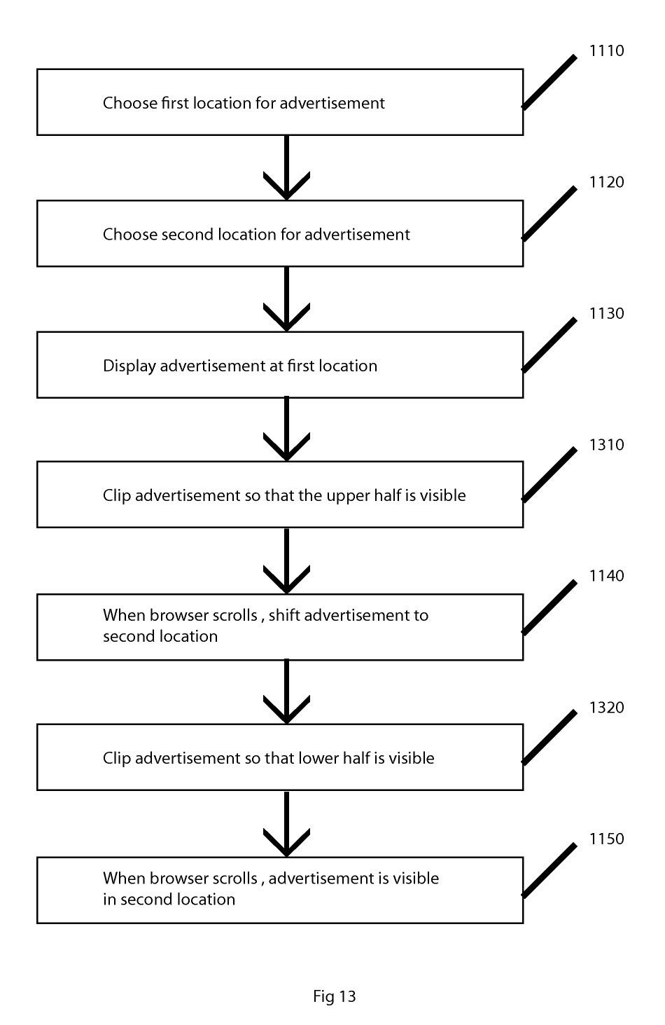

An embodiment is illustrated in FIG. 7, FIG. 8, FIG. 9, and FIG. 13. When a user views the same commercial message in an advertisement multiple times, the user might experience a kind of fatigue—where the user is less likely to respond to an advertisement's message. It will be better if the advertisement were to change the message it displays when it shifts location. That is, the user sees the same advertisement instance in the first and second location, but the appearance of the advertisement instance changes in each location. As shown in FIG. 7, an advertisement is designed in two halves—the upper half 710 has one message (represented by U), and the lower half 720 has another message (represented by L). It is a single advertisement instance, but it carries two messages. FIG. 8 illustrates how this would be shown to a user. The advertisement is shown at the top of the right-column. The advertisement is clipped 810 so that only the upper half 710 is visible when the advertisement is at its first location. FIG. 9 illustrates how the advertisement looks after the user scrolls down. The advertisement is clipped 910 so that only the lower half is visible when the advertisement is in its second location. The advertisement is loaded only once from the advertisement-server, its appearance on a page counts as only one impression on the server, yet it shows multiple messages to the user.

FIG. 13 is a flowchart of this embodiment. Steps 1110, 1120, 1130, 1140, and 1150 have already been discussed. Step 1310 is to clip the advertisement instance so that only the upper half is visible. Step 1320 is to clip the advertisement so that only the lower half is visible.

The functionality to clip the advertisement would typically be a part of a layout manager such as 1820.

In a web-page, an element (in this case the advertisement) can be clipped by placing the element inside a DIV with a CSS style of overflow:hidden. The DIV should have CSS styles for width and height. The DIV should be smaller than the element, so only a portion of the element is visible within the DIV's dimensions. The parts of the element that are outside the DIV (that is, the “overflow”) will be clipped. Different portions of the element can be clipped by altering the positioning of the element within the DIV. The position of the element can be altered by giving the element a CSS style of position:relative and by setting the “left” and “top” CSS properties. These CSS properties are changed by javascript when the advertisement is shifted from one location to another.

Software listing multimessage.html illustrates this embodiment. Open multimessage.html in a web-browser according to the instructions provided elsewhere in this specification. In the code, the DIV of ID “multimessageadvertisement” represents the composite advertisement. The DIV with id=“advertisementupper” represents the upper half and the DIV with id=“advertisementlower” represents the lower half. The upper half alone is shown when the browser is at the top of the page, and the lower half alone is shown when the browser is scrolled down.

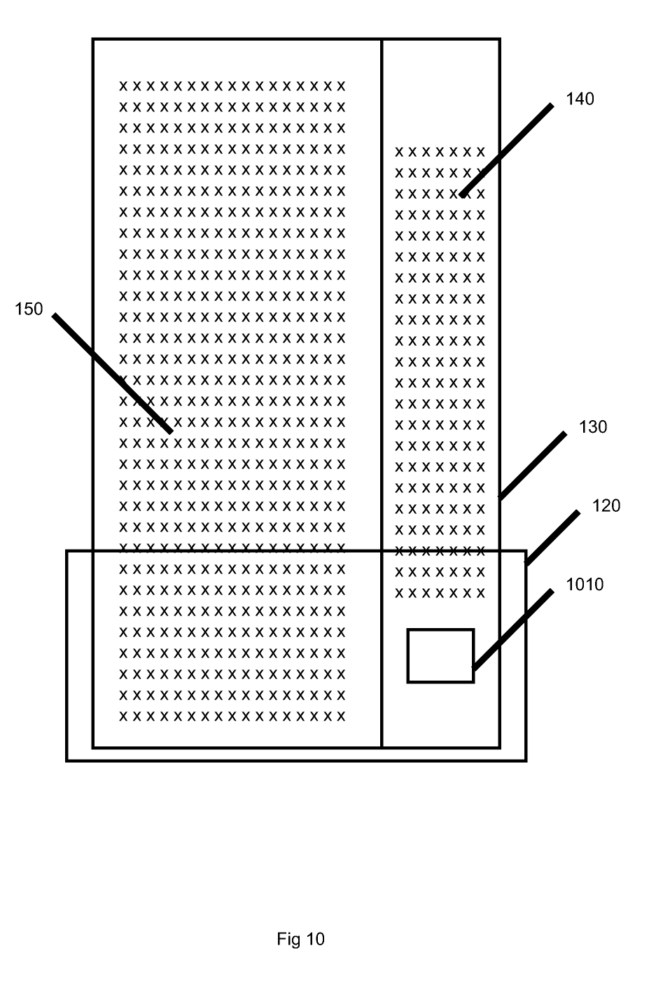

An embodiment is illustrated in FIG. 1 and FIG. 10. When the browser is at the top of the page, the advertisement instance is shown at full size. When the user scrolls down, the advertisement is resized 1010. This is useful when the second location is not large enough to contain the advertisement at full size, or for aesthetic considerations.

The functionality to resize the advertisement instance would typically be a part of layout manager such as 1820.

On a web-page, resizing an advertisement is also called “scaling” the advertisement. This is done using CSS styles. The CSS styles for scaling an element have different property names on different browsers. For example, there is “-moz-transform”, “zoom”, and so on. By using the appropriate CSS styles, the advertisement is scaled.

Software listing resizable.html illustrates this embodiment. Open the file according to instructions available elsewhere in this specification. There is a 728×90 advertisement at the top of the page. This is too wide to fit entirely within the left-column. When the user scrolls down, the advertisement is shown again in its second location. Initially the advertisement is shown at full size in the second location. After a period of time has elapsed, the advertisement is resized to be small enough to fit in the left-column. The user may expand and shrink the advertisement (in the second location) by clicking the links “EXPAND ADVERTISEMENT” and “(X) CLOSE” respectively.

The choice of when the advertisement instance shifts from one location to another can determine how visible the advertisement is to the user. There are two situations to consider:
1. The two locations are separated by more than the height or width of the browser: In this case both locations will not simultaneously be visible within the browser. Here the basic rule is that when the browser is over location1, then the advertisement instance will be shown in location1. When location2 is visible within the browser, then the advertisement instance will be at location2.
2. The two locations are closer together than the height or width of the browser: In this case, both locations can be visible simultaneously within the browser. In such situations, heuristics can be used to place the advertisement instance in that location which will seem most natural to the user, or in that location where the user is most likely to interact with it.

Some possible heuristics for choosing the best location of the advertisement instance (for case 2 above) include:
Choosing the location that is closest to the center of the browser window
Choosing the location that has the largest area within the browser window
Choosing the location that is closest to the top of the browser window and also below the top of the browser window
Choosing the location that is most visible to the user
   Other heuristics may be used.

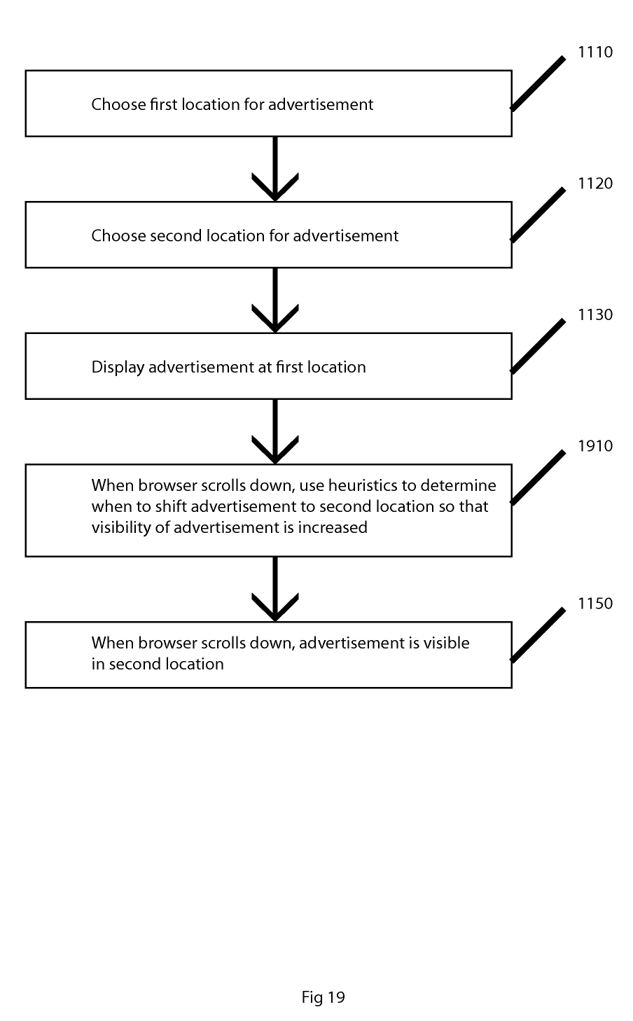

FIG. 19 is a flowchart for this embodiment. Step 1910 is to use a heuristic to determine where the advertisement should be at any point in time.

The functionality to implement the heuristic would typically be a part of layout manager such as 1820.

### Additional Embodiment

To design better heuristics, it will be useful to know how users scroll on a page. Once the scrolling behavior of users is known on a page, then a better heuristic for computing the advertisement's location can be determined for that page. Scrolling behavior is information related the scroll-position of the document within the viewport at different times.

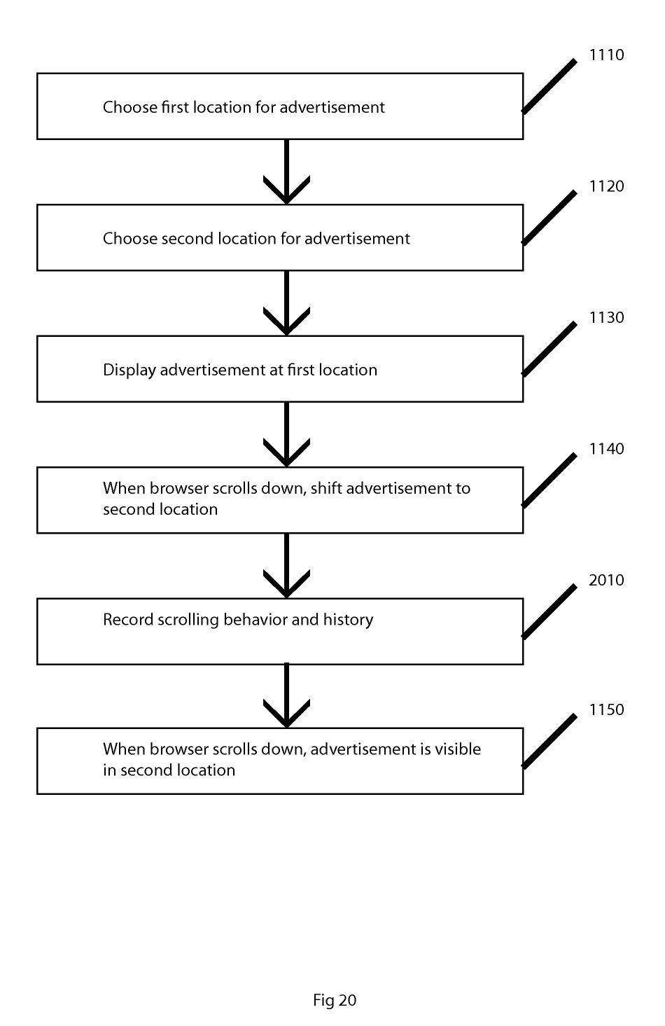

FIG. 20 is a flowchart of this embodiment. In step 2010, the scrolling behavior of each user is recorded. The browser sends the scrolling history to a server that records the data in a database for future analysis.

The functionality to record scrolling behavior would typically be a part of layout manager such as 1820.

### Additional Embodiment

Typically an advertisement's performance is measured through metrics such as click-through-rates. An advertisement with high click-through-rates is said to perform better. In the situation where an advertisement instance changes its location as a user scrolls, the choice of the first and second location can determine the clicks that the advertisement receives. To improve performance, it will be useful to measure the click-through-rate at each of the locations of the advertisement instance.

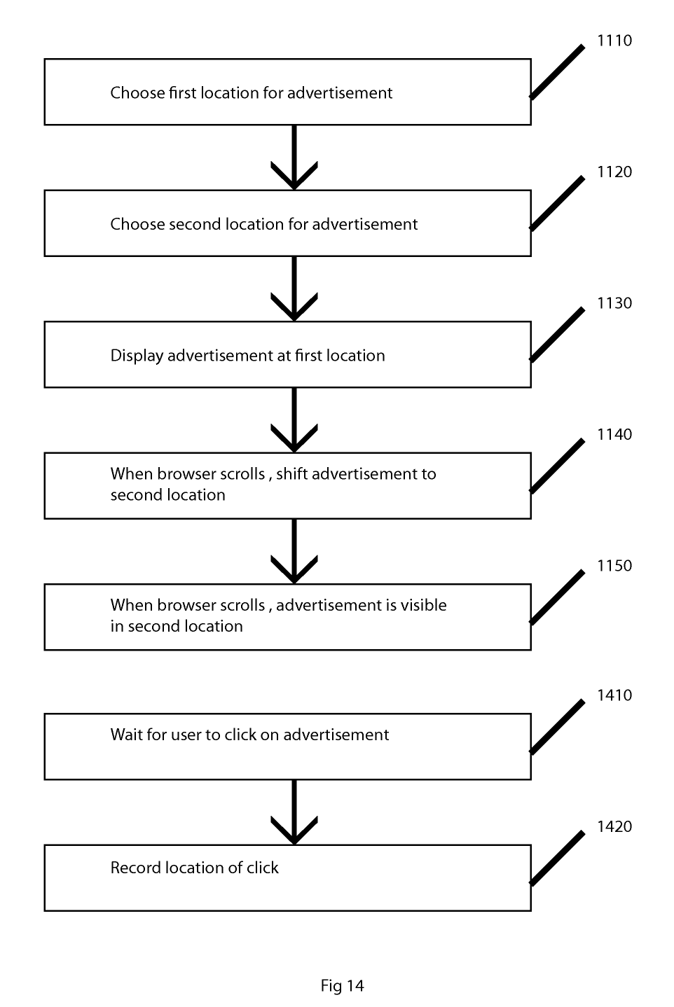

FIG. 14 is a flowchart of this embodiment. Step 1410 is to wait for a click (or some other interaction) with the advertisement. Step 1420 is to record the data associated with the interaction in a server. Steps 1410 and 1420 can be performed in parallel with steps 1110, 1120, 1130, 1140 and 1150. That is, the click can be recorded when the advertisement is at either the first location or the second location. Details of whether the advertisement was at the first or second location is also recorded.

The functionality to record interaction and click behavior would typically be a part of layout manager such as 1820.

Software listing record.html illustrates how clicks can be recorded. The server that records the click is not included in the listings. A suitable server that records the data from this file should read the server-request GET parameters “region”, “x”, and “y” from the request URL and record them to a database. To run this file, open it on a computer with a 2 Mbps internet connection (or faster) between the client and the server. Use Internet Explorer version 8. Use a network where connection establishment times (and ping times) between the client and the server are very fast. Before running, edit the file and change the second parameter of the javascript function call relona_track_clicks( )to be the actual server URL. The advertisement in this page initially appears as an empty rectangle in the top-right of the layout. This is an iframe. The iframe represents the advertisement. Clicking within the iframe will cause a GET request to be sent to the server URL.

### Additional Embodiment

Advertisements frequently contain animations. Animations attract users and help to improve engagement. Some advertisements have animations that run for a short period of (say) 15-30 seconds. When the advertisement is in its original location at the top of the page, the animation will play. But by the time users scroll down so that the advertisement becomes visible for a second time within the browser, the animation is very likely to have stopped. So performance of the advertisement in the second location can be poor. Instead, replaying animations when the advertisement comes into view in a new location can improve performance.

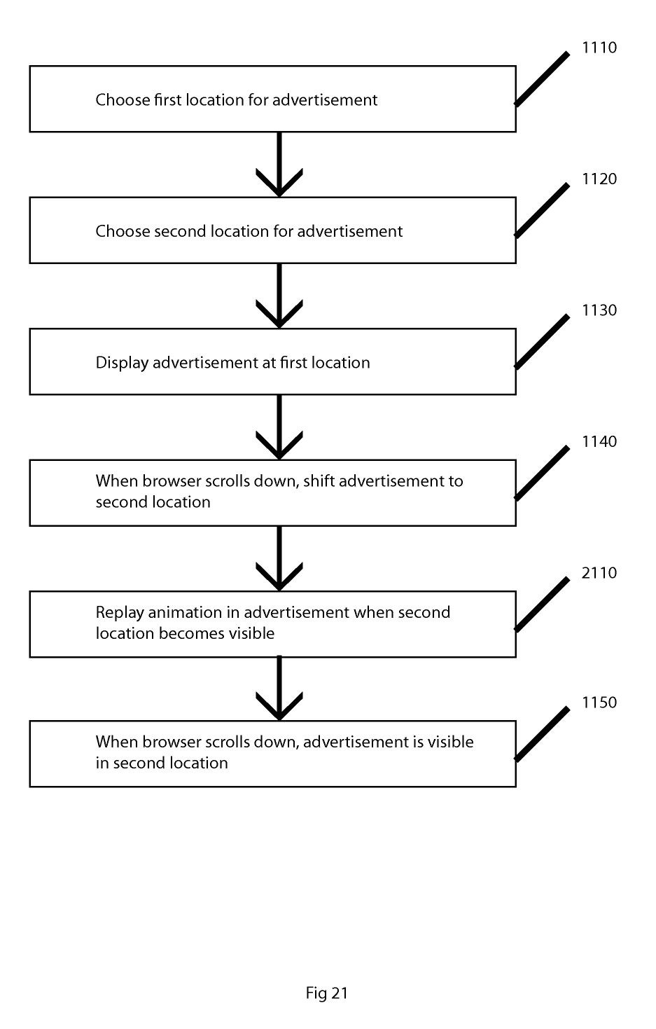

FIG. 21 is a flowchart of this embodiment. In step 2110, the animation is replayed (restarted) when the second location becomes visible within the browser.

### Additional Embodiment

When the first location and the second location are very close together, the shift in the advertisement's location from one to the other is noticeable by users. As the separation between the locations increases, the shift in the advertisement location will generally become less noticeable. Once the separation becomes greater than the height or width of the browser, then the shift will be from a location that is outside the browser window to another location that is also outside the browser window. Since the shift happens instantaneously between locations that are both invisible to the user, the user will not notice the shift at all. So choosing the second location of the advertisement instance so that it is separated from the first location by a vertical distance that is more than the height of the browser or a horizontal distance that is larger than the width of the browser viewport, will result in the user not noticing that the same advertisement instance is shifting location. Instead, the user might believe that the page contains two different instances of the advertisement.

That is, when the spacing between the first location and the second location is such that both cannot simultaneously appear within the browser, then the shift of the advertisement from one location to the other can be performed when both locations are not visible within the browser. This means that the user will not see the shift occur at all.

If the first and second location are chosen so that it is possible that both can be visible simultaneously within the web-browser, but the areas of each location that are visible simultaneously is relatively small, then the shift will be relatively unnoticed by users. That is, the separation between the locations can be slightly less than what is required to ensure they are never simultaneously visible within the browser, and the shift will still be relatively unnoticed.

The shift happens instantaneously. When the first location is visible within the browser, the advertisement is in the first location. When the second location becomes visible within the browser, the advertisement is shown in the second location.

Software listing multilocation.html can be used to illustrate this embodiment. When this is viewed in a browser window that is relatively small, the shift in the location of the advertisement will not be noticeable. If it is viewed in a large window (or if a large window is simulated by shrinking the browser contents by pressing Ctrl and “-” in Firefox) then the shift will become noticeable once the window becomes large enough and both locations fit into the window.

Choosing the second location so that it cannot be simultaneously shown along with the first location within the browser can prevent the user from noticing the shifting of the advertisement location.

The choice of the first and second location is usually made when the page layout is designed. In the case of dynamic content, the choice may be made when the page template is designed. But each user's web-browser window may be of a different height and width. There are two ways to deal with the different browser window dimensions:
1. The choice of the first and second location can be made after the browser dimensions are known. That is, when the page is being rendered on the browser, some javascript code on the page can dynamically choose the first and second location so that they are separated by a distance that is approximately equal to or greater than the dimension of the browser window. [Note: It is alright if the distance between the first and second location is slightly less than the height/width of the browser as the shift of the advertisement from one location to the other will be almost unnoticeable.]
2. The first and second location can be chosen to suit the average browser dimensions, or to be suitable for a large fraction of the possible browser dimensions. For example, if the average computer screen size is 1366×768 pixels, then the average browser window (i.e. the viewport) size might be 1326×650. The vertical dimension of the viewport is less than the screen height to allow for the browser address bar, buttons, toolbars and so on. The horizontal dimension of the viewport will also be less to allow for the scroll-bar. [Note: By height and width of the browser window, we mean the height and width of the actual web-page display area within the browser.] If the vertical separation between the first and second location were to be 600 pixels, then the shift in the location of the advertisement would be almost unnoticeable in a majority of the web browsers.

In situations where the first and second locations of the advertisement are separated by the height/width of the browser, it is alright if the space in between the two locations were to remain completely empty without any content.

The functionality to choose the second location such that its separation from the first location is approximately greater than the height or width of the browser would typically be a part of layout manager such as 1820.

### Additional Embodiment

Web pages frequently have areas of empty space in them. These areas form because web-pages are usually produced from a template. Templates are designed for content of average length. When the content is longer or shorter than average, empty spaces form on the page.

These empty spaces can be detected by measuring the dimensions of various elements on the page. Dimensions of elements can be measured by examining various CSS properties of the elements using javascript. If an empty area is large enough to contain the second location of an advertisement, then the advertisement instance is shifted there when the page is scrolled. If enough empty space is not available, the advertisement is not shifted to the second location at all.

Choosing the second location so that it is in empty areas of a page layout can result in better space utilization on the page.

### Alternative Embodiments

Instead of shifting an advertisement downwards when a user scrolls down, an alternative embodiment shifts the advertisement sideways when the page is scrolled horizontally.

Web-pages are a kind of interactive document. There are other kinds of interactive documents such as Adobe Acrobat pdf files, word-processing files that contain active script code, spread-sheet documents that interact with the user, e-book documents, interactive road-map, and so on. Any interactive document-like media that can contain an advertisement can be used in an embodiment. The contents within a standard GUI window can also be considered a document as long as the contents are scrollable within the window. A web-browser is a kind of viewport. A viewport displays a portion of an interactive document in a display and allows the document to be scrolled within it. Many different ways of scrolling are possible: by camera detected hand gestures, mouse clicks, touch-screen gestures, gestures that are detected by sensors behind the display screen, and so on. Scrolling refers to any means to change the portion of the document that is visible within the viewport. Scrolling can also be accomplished by rotating or moving the device itself. A viewport can be a window, or it can be the entire display screen of a device that displays a document. An advertisement is any element of an interactive document that produces a commercially useful benefit when readers/users of the document interact with it. An advertisement can be a flash media file, an image, a text link, a call to action, a form for the user to fill, an interactive game, SVG media, a video, a javascript and DHTML animation, and so on.

Instead of an advertisement, content which has to be shown to a user multiple times can be used. This has the benefit that the content is loaded only once from the server, but it is seen more often by the user.

Another embodiment uses a mobile application (i.e. application that runs on a mobile device such as a smartphone) as a viewport. Scrollable content within the application functions as an interactive document. An advertisement that is displayed within the application changes location when the content is scrolled.

Instead of using CSS positioning to shift an advertisement instance, the advertisement can be moved by using DOM calls to node.addChild( ) This will remove the advertisement from its old location and insert it into a new location in the DOM structure.

An advertisement instance can be shown in multiple locations, not just two. If the page is large, then it will be possible to show the advertisement in a larger number of locations.

### Advantages

From the description above, a number of advantages of some embodiments become evident:

The click-through rates of advertisements on web-pages can be increased by shifting the advertisements so that they are viewed multiple times by users as they scroll through the page.

Advertisements get more clicks, but they are loaded from the advertisement-server only once and they count as one impression on the server. Yet they are viewed multiple times by users. Since they are viewed more often by users, they get more clicks. More clicks for the same number of impressions results in a higher click-through-rate. Revenue from advertisements depends on the click-through-rate. Even if advertisers pay a publisher in terms of CPM rates, the advertisers will be willing to pay a higher CPM rate if the click-rate is higher. Higher click-rates on advertisements can directly improve earnings for a web-page owner/publisher.

Users generally dislike attempts to make advertisements more prominent. When the first and second locations are separated by enough distance such that both together cannot simultaneously appear within the web-browser, then the user will not notice the shift in location of the advertisement. The user will usually believe that multiple instances of the advertisement are being shown instead of the same advertisement instance being shifted. Since users don't notice the advertisement instance being shifted, they will not dislike this system.

When content (non-commercial elements in the document) is shifted from location to location so that it appears as though multiple instances of the content are on the page, it results in a lower page-size (in terms of bytes downloaded).

When space originally occupied by an advertisement is reclaimed, it allows one (or more) advertisements to be shown multiple times without consuming extra space on the page layout.

When an advertisement is shown at a second location which is situated in an area where the layout would otherwise have had empty space, it results in better utilization of space on the page-layout.

### CONCLUSION, RAMIFICATIONS AND SCOPE

Accordingly the reader will see that this process improves the earnings of a web-site publisher by:
Increasing the click-through-rates of advertisements
Improving utilization of space that would otherwise have been left empty
Reducing page-size (in terms of bytes downloaded)
Avoiding user annoyance by making it appear as though there are multiple instances of the advertisement on the page. Users don't notice the advertisement shifting location.

Although the description above contains many specifics, these should not be construed as limiting the scope of the embodiments but as merely providing illustrations of some of several embodiments. For example, instead of a web-page, any kind of interactive document can be used; instead of a browser, any kind of viewport that displays a portion of the document can be used; instead of an advertisement, any kind of content can be used; the document can be in an application on a mobile device that is displaying scrollable data within the application; and so on.

Thus the scope of the embodiments should be determined by the appended claims and their legal equivalents, rather than by the examples given.

### Source Code

Place all the source files in the same directory on a computer running the 32 bits version of the Microsoft Windows 7 operating system with a display resolution of 1366 pixels horizontally and 768 pixels vertically. Memory should be 2 GB or more. The computer should have Firefox 3.5 and Internet Explorer 8 installed on it. Rename the files as follows:
Rename multilocation_dot_html.txt to multilocation.html
Rename multimessage_dot_html.txt to multimessage.html
Rename record_dot_html.txt to record.html
Rename resizable_dot_html.txt to resizable.html
Rename script_dot_js.txt to script.js
Rename shufflejump_dot_html.txt to shufflejump.html
Rename shufflesmooth_dot_html.txt to shufflesmooth.html
Rename shufflestep_dot_html.txt to shufflestep.html

Each of the html files (except record.html) can be opened in a browser by double clicking on it. Right-click the mouse to get a menu that lets you choose either Internet Explorer 8 or Firefox to open the file. Another way to open these files is to place all the files in the same directory of a web-server. Then each of the html files can be opened using the URL of the file on the web-server. The record.html file should be placed along with script.js in the same directory of a web-server and opened through a browser by entering the URL of the record.html file. Microsoft's IIS version 7.5 and Apache's web-server version 2.2 are both suitable. The record.html file should not be opened directly by double clicking the filename in windows-explorer; it should be opened by hosting it on a web-server and entering the URL into a browser. The advertisement within record.html will initially appear as an empty rectangle in the top-right of the layout. This is an iframe and it represents an advertisement.

Some browsers may by default block ActiveX, Javascript and other components on pages. All security restrictions must be disabled and all permissions must be granted for the pages to display properly. Javascript must be enabled.

### Definitions of Terms

A document is any human readable collection of media (including bitmap images, vector drawings, video, audio and vector animation) and/or text.

An interactive document is a document which can interact with a human user and change the text and media in response to the interactions. An “interaction” between the document and the human can include a click with a mouse, a touch on the document using a touch-screen device, a hover of a mouse cursor over an element in the document, scrolling through the document, panning through the document, dragging items on the document, viewing some particular portion of the document for a long time, and so on. An interaction is not limited to just clicking.

An interaction is any kind of human behavior that can be detected by the document. An interactive document is one that responds in any manner to such interactions.

A viewport is a means to display a portion of an interactive document to a human user. A viewport may be a window, or it might be the entire display device. When the interactive document is larger than the viewport (in the horizontal dimension, the vertical dimension, or both) then the viewport will be able to display only a portion of the interactive document. For the human user to be able to interact with the entire document, the human is provided with means to scroll the document within the viewport.

An advertisement is any element or collection of elements in the document, such that interaction of the human user with the element (or group of elements) produces a commercial benefit.

The CTR, Click-Through-Rate, or Click-Rate (expressed as a percentage) is the number of clicks an advertisement gets for every 100 impressions.

CPM is the amount of money paid by an advertiser for every 1000 impressions on the website.

The invention claimed is:

1. A process of showing an advertisement instance in a scrollable viewport of a data processing system comprising
Showing an interactive document within said scrollable viewport,
Choosing a first location within said interactive document that is suitable for displaying said advertisement instance,
Choosing a second location within said interactive document that is suitable for displaying said advertisement instance such that said first location and said second location are separated by other document items,
Displaying said advertisement instance in said first location,
Scrolling said interactive document in said viewport,
Determining when said second location is visible within said viewport,
Shifting said advertisement instance to said second location,
Whereby said advertisement instance is seen multiple times within said viewport as a user scrolls through said interactive document.

2. The process of claim 1 further comprising reclaiming space occupied by said advertisement instance at said first location.

3. The process of claim 1 further comprising clipping said advertisement instance to show a first portion when said advertisement instance is at said first location and clipping said advertisement to show a second portion when said advertisement instance is at said second location.

4. The process of claim 1 further comprising resizing said advertisement instance.

5. The process of claim 1 further comprising applying heuristics to increase visibility of said advertisement instance.

6. The process of claim 1 further comprising recording scrolling history of said interactive document.

7. The process of claim 1 further comprising replaying animation in said advertisement instance.

8. The process of claim 1 further comprising activating said advertisement instance and recording location information associated with said advertisement instance on computer storage.

9. The process of claim 1 further comprising restricting choice of said first location and said second location such that at least one of said first location or said second location is mostly outside said viewport.

10. A data processing system comprising
A viewport that displays an interactive document to a user,
A means to scroll said interactive document within said viewport,
An advertisement instance associated with said interactive document,
A means for displaying said advertisement instance at a first location within said interactive document,
A means for choosing an alternative location for said advertisement instance such that said alternative location is separated by document items from said first location,
A means for shifting said advertisement instance to said alternative location within said interactive document,
A means for determining when said alternative location is visible within said viewport,
Whereby said advertisement instance is visible to said user for a longer period of time within said viewport.

11. The data processing system of claim 10 further comprising means to reclaim space used by said advertisement instance in said first location.

12. The data processing system of claim 10 further comprising means to clip a portion of said advertisement instance.

13. The data processing system of claim 10 further comprising means to resize said advertisement instance.

14. The data processing system of claim 10 further comprising means to activate said advertisement instance and means to record location information associated with said advertisement instance.

15. The data processing system of claim 10 where said means for choosing an alternative location further ensures that at least one of said first location or said alternative location is mostly outside said viewport.

16. A process of showing a first advertisement instance and a second advertisement instance in a scrollable viewport of a data processing system comprising
Showing an interactive document within said scrollable viewport,
Choosing a first location within said interactive document,
Choosing a second location within said interactive document,
Displaying said first advertisement instance in said first location,
Scrolling said interactive document in said scrollable viewport,
Displaying said second advertisement instance in said second location,
Reclaiming space occupied by said first advertisement instance in said first location,
Whereby both of said first advertisement instance and said second advertisement instance together occupy a smaller total quantity of space in said interactive document.

17. The process of claim 16 where reclaiming space further comprises rearranging layout of said interactive document in small steps.
